(19) United States
(12) Patent Application Publication
(10) Pub. No.: US 2004/0248565 A1
(43) Pub. Date: Dec. 9, 2004

(54) METHOD FOR CONTROLLING A CELLULAR PHONE

(76) Inventor: Hsin-Hsien Yu, Kao-Hsiung Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/709,937

(22) Filed: Jun. 8, 2004

(30) Foreign Application Priority Data
Jun. 9, 2003 (TW) 092115608

(51) Int. Cl. H04M 3/00

(52) U.S. Cl. 455/418; 455/412.1

(57) ABSTRACT

A method for controlling a cellular phone having a memory and a clock. The method includes storing a time and a content of work executed at the time into the memory, taking statistics of each time of the work, and controlling the cellular phone according to the statistics and the time counted by the clock.

### BACKGROUND OF INVENTION

1. Field of the Invention

The present invention relates to a method for controlling a cellular phone, and more specifically, to a method for controlling a cellular phone according to the time and the content of work performed at that time.

2. Description of the Prior Art

In a modern information-oriented society, compact cellular phones are widely used. By these cellular phones, people exchange information with others all around the world for better communications.

Generally, users employ cellular phones regularly. For example, in case of businessman A, he may turn on his cellular phone regularly at 8:00 a.m. every Monday to Friday, read online news utilizing the phone at 8:30 a.m., browse search for stock information at 10:00 a.m., call his wife at noon, call his son's teacher at 6:30 p.m. and turn off the phone at 11:00 p.m. For another example, in case of a student B, he may send a message to his girlfriend by his cellular phone at 9:00 a.m., and call her at 10:00 p.m. every night.

However, regular schedules may be broken by busy life. For example, businessman A may forget to turn on his phone because he is in a hurry to go to work. He may forget to check for stock information because he is busy with work. Similarly, businessman A may forget to call his son's teacher and student B may forget to call his girlfriend.

Besides, though the remaining battery power indicator is shown on the screen, a cellular phone does not provide enough information to its user for indicating the exact remaining power of the battery. For example, the cellular phone shows five markings when the battery is full and one marking when the battery is exhausted. However, even if the battery power indicator of the phone shows only one marking, the battery may keep on working for a few hours and the user may not charge the phone instantly, leading to, in some cases, a proceeding call being dropped when the battery stops working.

### SUMMARY OF INVENTION

It is therefore a primary objective of the claimed invention to provide a method for controlling a cellular phone to solve the problems mentioned above.

According to the claimed invention, a method for controlling a cellular phone is disclosed. The cellular phone includes a memory and a clock. The method includes storying a time and a content of work executed at that time into the memory, taking statistics of each time of the work, and controlling the cellular phone according to the statistics and the time counted by the clock.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a cellular phone according to the present invention.

FIG. 2 is a flowchart of how the personal information manager controls turning on the cellular phone.

FIG. 3 is a flowchart of how the personal information manager controls connecting the cellular phone to a network.

FIG. 4 is a flowchart of how the personal information manager reminds the user to make a call.

FIG. 5 is a flowchart of how the personal information manager controls showing the remaining time on the cellular phone.

FIG. 6 is a flowchart of how the personal information manager warns the user of phone charges.

FIG. 7 is a flowchart of a dismissal of the personal information manager.

FIG. 8 is a flowchart of a temporary turn-off of the personal information manager.

FIG. 9 is a flowchart of how the personal information manager operates after the password of the cellular phone is changed.

### DETAILED DESCRIPTION

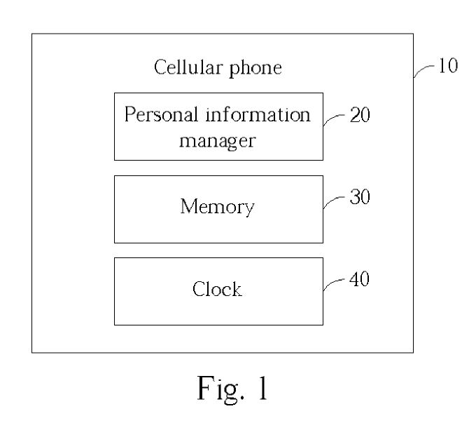

Please refer to FIG. 1 showing a block diagram of a cellular phone 10 according to the present invention. The cellular phone 10 includes a personal information manager 20, a memory 30, and a clock 40. The personal information manager 20 may be a logic circuit or program code stored in the memory 30. The personal information manager 20 can manage a network connection, communications, power system, and security according to the status of the cellular phone 10 by statistics and calculation.

Assume that a Mr. A gets up regularly at 7:30 a.m. and turns on the cellular phone 10 every Monday through Friday. The personal information manager 20 will store the time (7:30 a.m., every Monday through Friday) and the work (turning on the phone 10) to the memory 30.The personal information manager 20 then takes statistics of the content of the work (turning on the cellular phone 10) and the time (7:30 a.m. every Monday through Friday) the work is executed so as to operate the cellular phone 10 accordingly. That is, after the statistics are finished, the personal information manager 20 will turn on the phone at 7:30 a.m. every Monday through Friday automatically without manual operation.

Although the personal information manager 20 turns on the phone at 7:30 a.m. every Monday to Friday, Mr. A can still turn on the phone before it is automatically turned on by the personal information manager 20. For example, if Mr. A gets up at 6:00 a.m., he can turn on the cellular phone 10 at any time. In this example, suppose that Mr. A turns on the cellular phone 10 at 6:00 a.m. and leaves the cellular phone 10 turned on. Since the phone is already turned on manually, the personal information manager 20 will not turn on the phone at 7:30 a.m., but will store this record (the cellular phone 10 was turned on at 6:00 a.m.) into the memory 30. If the statistics show that turning on the phone at 6:00 a.m. is not habitual, the personal information manager 20 will continue to turn on the phone at 7:30 a.m., Monday through Friday, as usual. However, if the statistics show that Mr. A has changed his personal habit to now turn on the cellular phone 10 at 6:00 a.m. every Monday through Friday, the personal information manager 20 will automatically change the time for turning on the cellular phone 10 from 7:30 a.m. to 6:00 a.m. and turn on the cellular phone 10 at 6:00 a.m. every Monday through Friday after the time change is made. In addition to turning on the phone, the personal information manager 20 can also turn off the phone in a similar way.

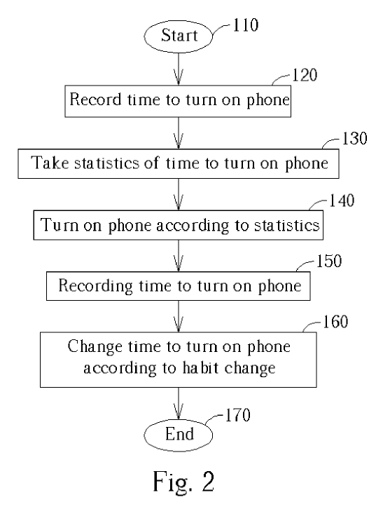

Please refer to FIG. 2 showing a flowchart of how the personal information manager 20 turns on the cellular phone 10.

Step 110: Start.

Step 120: Store the time and the content of work (turning on the cellular phone 10) into the memory 30.

Step 130: Take statistics of the content of work (turning on the cellular phone 10) and the time which the cellular phone 10 is turned on.

Step 140: Turn on the cellular phone 10 according to the statistics and the time shown by the clock 40.

Step 150: Keep on recording the time which the cellular phone 10 is turned on.

Step 160: If the time which the cellular phone 10 is turned on changes, check whether the change is unusual or habitual. If the change is unusual, do not change the time to turn on the cellular phone 10. If the change is habitual, change the time to turn on the cellular phone 10.

Step 170: End.

In case of a network, assume that a Ms. B reads online news regularly at 8:00 a.m. everyday. The personal information manager 20 will store the time (8:00 a.m.) and the work (reading online news by the cellular phone 10) into the memory 30, and take statistics of the content of the work (reading online news by the cellular phone 10) and the time (8:00 a.m.) that the work is executed everyday to control the cellular phone 10.That is, after the statistics are finished, the personal information manager 20 will connect to the news website before 8:00 a.m. everyday to save the time on downloading.

Although the personal information manager 20 connects to the news website before 8:00 a.m. everyday, Ms. B can execute other work instead at 8:00 a.m. For example, if Ms. B does not want to look over the website connected by the personal information manager 20 before 8:00 a.m. but receives mail and notices of meetings instead, the personal information manager 20 will store this record (receiving mail and notices at 8:00 a.m.) into the memory 30. If the statistics show that receiving mail and notices of meetings at 8:00 a.m. is unusual, the personal information manager 20 will keep on connecting to the news website before 8:00 a.m. everyday. However, if the statistics tics show that Ms. B has changed her personal habit to receive mail and notices of meetings instead of reading online news, the personal information manager 20 will automatically download mail and notices of meetings before 8:00 a.m. everyday. If Ms. B changes her personal habit again not to receive mail and notices of meetings nor other things, the personal information manager 20 will not execute any work at 8:00 a.m.

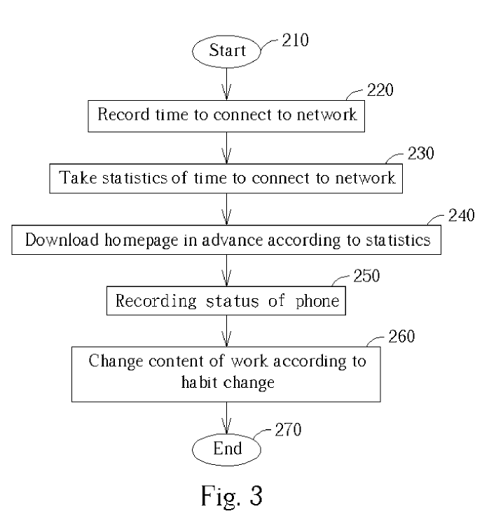

Please refer to FIG. 3 showing a flowchart of how the persoanl information manager 20 connects the cellular phone 10 to the network.

Step 210: Start.

Step 220: Store the time and the work (connecting the cellular phone 10 to the network) into the memory 30.

Step 230: Take statistics of the work (connecting the cellular phone 10 to the network) and the time which the work is executed.

Step 240: Download the website read regularly by the user according to the time the cellular phone 10 was connected to the network and the time shown by the clock 40.

Step 250: Keep on recording the status of the cellular phone 10.

Step 260: If the content of the work changes, check whether the change is unusual or habitual. If the change is unusual, do not change the time to connect the cellular phone 10 to the network. If the change is habitual, change the content of the work.

Step 270: End.

In case of communications, assume that Mr. A calls his girlfriend regularly at 11:00 p.m. everyday. The personal information manager 20 will store the time (11:00 p.m.) and the work (calling the girlfriend) into the memory 30, and take statistics of the content of the work (calling the girlfriend) and the time to execute the work (11:00 p.m. everyday) to control the cellular phone 10. That is, after the statistics are finished, the personal information manager 20 will generate a message which can be a text message, vibration, or ringing to remind Mr. A to call his girlfriend. Although the personal information manager 20 reminds Mr. A to call his girlfriend at 11:00 p.m. everyday, if Mr. A starts regularly calling his girlfriend at 11:30 p.m. everyday instead of 11:00 p.m., the personal information manager 20 will remind him to call his girl friend at 11:30 p.m. instead of 11:00 p.m. after that.

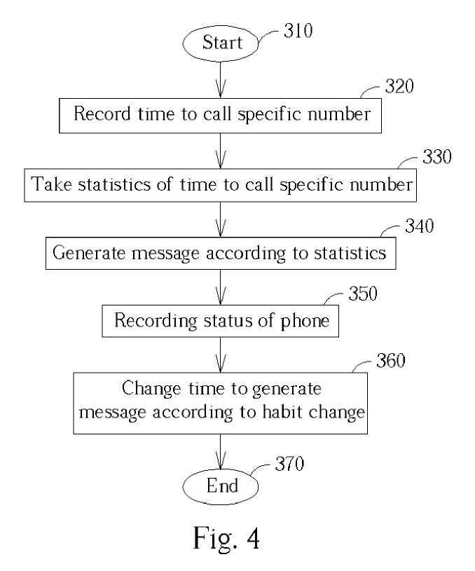

Please refer to FIG. 4 showing a flowchart of how the personal information manager 20 to remind the user to call as specific number at a specific time.

Step 310: Start.

Step 320: Store the time and the work (calling a specific number) into the memory 30. Take statistics of the work (connecting the cellular phone 10 to the network) and the time which the work is executed.

Step 330: Take statistics of the work (calling out the specific number) and the time which the work is executed.

Step 340: Remind the user at the time to call the specific number according to the time which the user used to call the specific number stored in the memory 30.

Step 350: Keep on recording the operation time and content of the cellular phone 10.

Step 360: If the user changes the time to call the specific number, check whether the change is unusual or habitual.

If the change is unusual, do not change the time to remind the user to call the specific number. If the change is habitual, change the time to remind the user to call the specific number.

Step 370: End.

In a case of system power indication in this invention, assume when the battery power of the cellular phone 10 is fully charged, the power supply is approximately E, the power consumption when the phone 10 connects to the internet is P1, the power consumption when the phone 10 being at stand-by mode is P2, and the power consumption at calling mode is P3. Thus E=P1*t1+P2*t2+P3*t3, where t1 is the total time for the phone 10 connecting to the internet after the battery is fully charged, t2 is the total time for being at stand-by mode after the battery is fully charged, and t3 is the total time for calling after the battery is fully charged. Based on this relationship, the personal information manager 20 will store the corresponding time of connecting to the internet, being at the stand-by mode, and for calling mode respectively into the memory 30, and take the statistics of them to calculate E, P1, P2 and P3. When E, P1, P2 and P3 are known, the personal information manager 20 can show the remaining time for connecting to the network, or being at the stand-by mode, or at the calling mode according to the statistics so that the user can know the power status of the cellular phone 10.

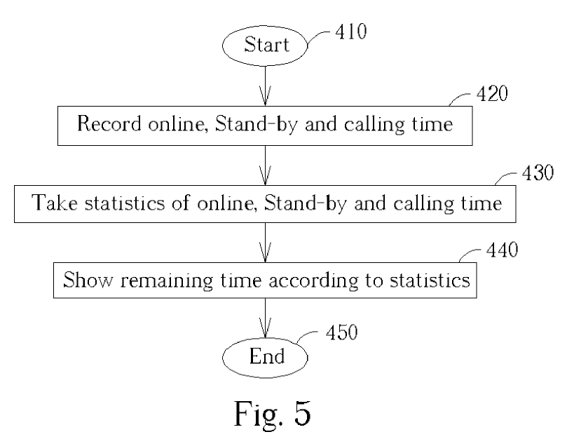

Please refer to FIG. 5 showing a flowchart of how the personal information manager 20 shows the remaining time for the power supply status on the cellular phone 10.

Step 410: Start.

Step 420: Store the time for connecting to the network, for stand-by, and for calling (after the battery is fully charged) into the memory 30.

Step 430: Take statistics of the time for connecting to the network, for stand-by, and for calling (after the battery is fully charged).

Step 440: Show the remaining time for connecting to the network, for stand-by, and for calling on the screen of the cellular phone 10, according to the time for connecting to the network, for stand-by, and for calling (after the battery is fully charged).

Step 450: End.

In addition, the personal information manager 20 can store the online(connecting to the internet) time and the calling time per month into the memory 30, and take statistics of the online time and the calling time per month to calculate an average value and show the average value of the online time and/or the average value of calling time per month on the screen of the cellular phone 10. Obviously, the actual online time and/or actual calling time may be shown on the screen of the cellular phone 10 in addition to or in place of the respective average values in another embodiment of the present invention. If the online time and the calling time of the month reach the average value, the personal information manager 20 will generate a warning message to alert the user.

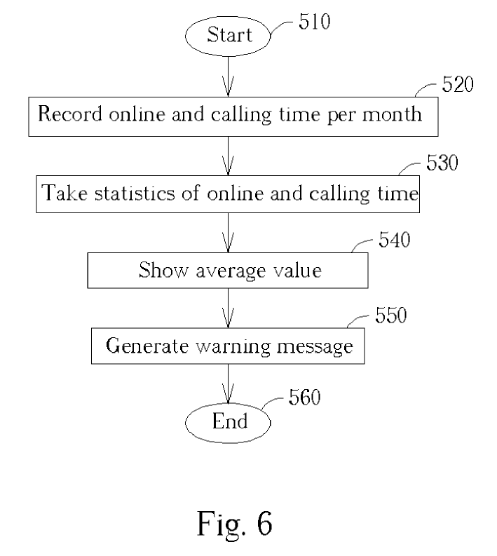

Please refer to FIG. 6 showing a flowchart of how the personal information manager 20 alerts the user to take care of phone charges.

Step 510: Start.

Step 520: Store the online time and the calling time per month into the memory 30.

Step 530: Take statistics of the online time and the calling time per month.

Step 540: Show the average values of the online time and the calling time per month on the screen of the cellular phone 10.

Step 550: Generate a warning message when the online time and/or the calling time of the month reach the respective average value.

Step 560: End.

The personal information manager 20 is an additional function of the cellular phone 10, thus its activation is optional. In situation where the personal information manager 20 is activated, when the user is going to give the phone to another friend or delete the records in the memory 30, he can “dismiss” the personal information manager 20. After the personal information manager 20 is dismissed, the records in the memory 30 will be erased and the personal information manager 20 will stop all its operations of recording, statistics, and controlling. However, if the password of the cellular phone 10 is changed within a week, the personal information manager 20 cannot be dismissed, because the personal information manager 20 will trace the way the user uses the cellular phone 10 in order to determine whether the phone is under illegal occupation.

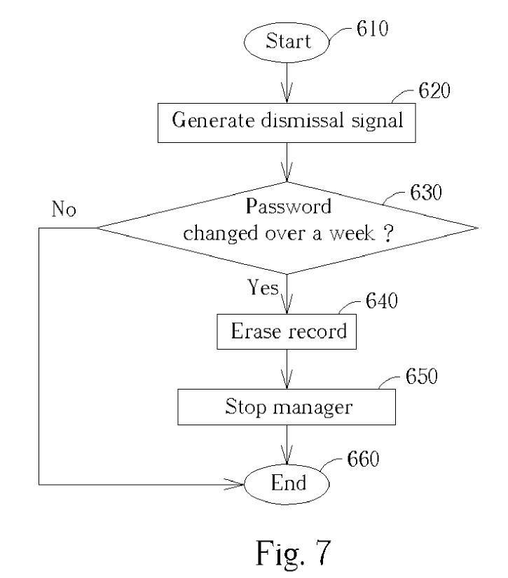

Please refer to FIG. 7 showing a flowchart of the dismissal of the personal information manager 20.

Step 610: Start.

Step 620: Generate dismissal signal.

Step 630: Detect whether the password has been changed within a week. If yes, proceed to Step640, and if no, proceed to Step 660.

Step 640: Erase the record(s) in the memory 30.

Step 650: Stop all recording, statistics, and controlling operations by the personal information manager 20.

Step 660: End.

In a situation of the user being abroad, personal habits may change. During this time, the user can temporarily turn off the personal information manager 20. In this case, the personal information manager 20 will no longer generate any notices, but can still detect or be stopped from detecting the status of the cellular phone 10. In a case of the personal information manager 20 detecting the status, the personal information manager 20 will not take new statistics of the time of each work, but judge whether the phone is under illegal occupation according to the original statistics.

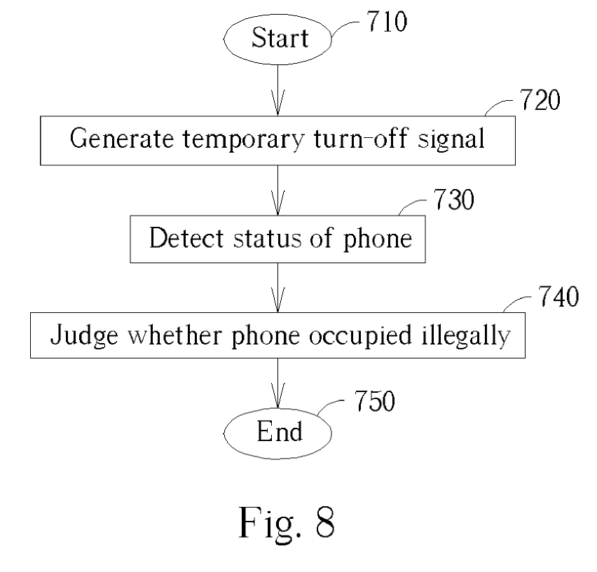

Please refer to FIG. 8 showing a flowchart of a temporary turn-off of the personal information manager 20.

Step 710: Start.

Step 720: Generate temporary turn-off signal.

Step 730: Keep on detecting the status of the cellular phone 10.

Step 740: Judge whether the phone is under illegal occupation according to the original statistics.

Step 750: End.

For security reasons, when the password of the cellular phone 10 is changed, the personal information manager 20 cannot be dismissed for a week. After a week, the personal information manager 20 will compare the time and the content of work of the cellular phone 10 before and after the password was changed before dismissal. If a change of habit is discovered (e.g. most often called numbers have been not called while new numbers are frequently called), the personal information manager 20 can judge that the cellular phone 10 is under illegal occupation and send a message to the most often called number to alert him or her to the fact that “Mr. A's cellular phone is under illegal occupation. Please take care.” so that they can call Mr. A for confirmation. If the cellular phone 10 of Mr. A is under illegal occupation, it can be found by GPS (global positioning satellite). Even when the personal information manager 20 is temporarily turned off, the personal information manager 20 can still detect the status to judge whether the phone is under illegal occupation.

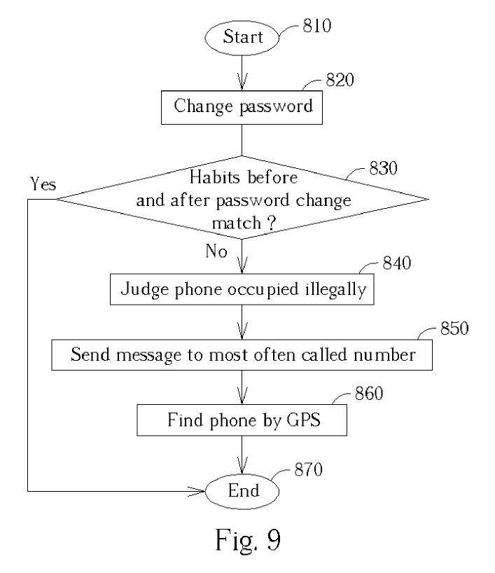

Please refer to FIG. 9 showing a flowchart of how the personal information manager 20 operates after the password of the cellular phone 10 is changed.

Step 810: Start.

Step 820: Change the password.

Step 830: Compare the habits for using the cellular phone 10 before and after the password was changed. If they do not match, proceed to Step 840. If they match, proceed to Step 870.

Step 840: Judge that the cellular phone 10 is under illegal occupation.

Step 850: Send a message to the most often called number.

Step 860: Find the cellular phone 10 by GPS.

Step 870: End.

In contrast to the prior art, the personal information manager 20 according to the present invention can store the status of the cellular phone 10 into the memory, and take statistics of the status in order to control the cellular phone 10. In busy daily life, the method provided by the present invention can remind the user not to forget important tasks to do.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for controlling a cellular phone, the cellular phone comprising a memory and a clock, the method comprising:
(a) storing a time and a content of work executed at the time into the memory;
(b) taking statistics of each time of the work; and
(c) controlling the cellular phone according to the statistics and the time counted by the clock.

2. The method of claim 1 wherein the content of work comprises turning on the cellular phone, turning off the cellular phone, dialing, sending messages, browsing homepages, downloading data from homepages, and showing remaining power of the cellular phone.

3. The method of claim 1 further comprising stopping storing the time and the content of work executed at the time into the memory.

4. The method of claim 1 further comprising stopping taking the statistics of each time of work.

5. The method of claim 1 further comprising stopping controlling the cellular phone according to the statistics and the time counted by the clock.

6. The method of claim 1 wherein step (c) is to control the cellular phone to generate a message according to the statistics and the time counted by the clock.

7. The method of claim 6 wherein the message is a ringing tone.

8. The method of claim 6 wherein the message is a text message.

9. The method of claim 6 wherein the message is vibration.

10. The method of claim 1 further comprising:
after a password of the cellular phone is changed for a period of time, comparing each time and content of work after the password was changed with the statistics on the time and the content of work before the password was changed; and
if the time and the content of work after the password was changed do not substantially match the statistics on the time and the content of work before the password was changed, generating a message according to a callout record of the cellular phone before the password was changed.

11. The method of claim 1 wherein step (c) is to control the cellular phone when the clock of the cellular phone reaches the statistics on the time obtained in step (b).

12. A cellular phone for implementing the method of claim 1.
